(19) United States
(12) Patent Application Publication
(10) Pub. No.: US 2019/0136606 A1
(43) Pub. Date: May 9, 2019

(54) WINDOW INSTALLATION APPARATUS

(71) Applicant: WLODZIMIERZ GROBELNY, Przezmierowo (PL)

(72) Inventor: WLODZIMIERZ GROBELNY, Przezmierowo (PL)

(21) Appl. No.: 16/098,825

(22) PCT Filed: Mar. 10, 2017
(86) PCT No.: PCT/PL2017/000025

§ 371 Date: Nov. 2, 2018

(30) Foreign Application Priority Data
May 2, 2016 (PL) P.417068

(51) Int. Cl. E06B 1/60; E04F 21/00

(52) U.S. Cl. CPC E06B 1/6069; E04F 21/0015

(57) ABSTRACT

The herein described invention is a window installation apparatus comprising of at least one wedge-shaped distance piece. The apparatus according to the invention comprises a body (1) connected in a sliding manner to a clamp (3) between which an expansion unit is positioned, comprising at least one wedge (6) and a lead screw (9) connected by means of a threaded connection with an opening (12) of the wedge (6), wherein the body (1) has protrusions (2) positioned at its opposite sides, lateral rails (5) mating with brackets (4) of the clamp (3) and an opening (10) in a rest wall (11) for the lead screw (9), while the outer walls (7) of the wedge (6) and the inner walls (8) of the body (1) and the clamp (3) converge downward at the same angle.

The herein described invention is an apparatus for window installation in the window opening.

The most common method of window installation in the window opening is known for years and consists in securing the frame by positioning it parallel to the wall, at a certain distance from its surface, simultaneously ensuring that the window is aligned vertically and horizontally. This method requires the installer to use a set of wooden wedges for preliminarily securing the frame. The wedges are delicately driven between the frame and the surface of the window opening. However, this method is problematic for a single installer, because it is not easy to perform with two hands only and thus requires a considerable amount of skills and experience. Namely, the installer must simultaneously hold the frame, insert a wooden wedge underneath it and drive it in with a hammer to secure it in place. As the wedge is being driven in, it secures the fame but simultaneously moves it relative to the outside surface of the wall. As a result, the procedure must be repeated several times and a spirit level must be used to ensure that the frame is vertically aligned. Consequently, window installation is often flawed in many ways, the most common issue being excessive clearance between the frame and the window opening.

The description of the utility model PL.107340 (U1) teaches a set of installation wedges shown in drawing Pos. I, characterized in that both the upper (3) and the bottom (4) surface of each wedge (1, 2) has preformed transverse ridges, and both these surfaces have preformed transverse rectangular cavities (6) shaped symmetrically to one another, and each lateral surface (7) of each wedge has guide protrusions, extending beyond the outline.

The international application WO2005068749 (A1) teaches a distance (expansion) piece that can replace a traditional wedge for fitting a window to an opening of a building, as shown in drawing Pos. II. In this embodiment, the distance piece consists of two part (2, 3) having inner surfaces (4, 5) facing towards each other and outer surfaces (7, 8) forming outer parts of the distance piece. The outer surface comprises resilient protrusions (15) located in cavities of the surfaces (23).

Importantly, the parts (2, 3) are movable relative to each other and can expand forming a wedge, whose cross-section forms an isosceles triangle. The parts can also be contracted. They are separated by means of a separation part (9) comprising a lock (17) and an ergonomically shaped grip (18) provided with a non-slippery surface. During use, the separation part (9) is inserted between the two parts (2, 3) which are apart. The separation part (9) is adapted to move linearly in the inner space to effect the movement of the set of first contact portions (10, 11), and those portions expand the parts (2 and 3). In addition, the parts (2, 3) are flexibly connected by means of a resilient connecting element, preferably taking the form of rubber bands. The two circumferentially extending grooves (21) serve to fixate two of such rubber bands in place.

All parts of the distance piece can be made of wood or steel or made of a polymeric or ceramic material, a composite material comprising fibres of glass, carbon or Kevlar (polymer material).

The description of the international application WO2005102609 (A1) (also published as GB2413352 (B)) teaches a door support and alignment kit, as shown in drawing Pos. III. The kit comprises an elongated block (10) having a transverse slot (11) formed with two recesses (13, 15). Recess (13) receives a single wedge (12) while recess (15) can receive secondary wedges (14) positioned side-by-side.

A door (D) can be stood on its edge and engaged in the transverse slot (11) and rested on the upper surface of web (10A). Wedge (12) is slid into the transverse slot (11) alongside one face of the door (D), to wedge the door against end surface (11b), and hold the door vertically. Once the door has been planed to size, and positioned within the door frame, smaller wedges (14) can be inserted into the gaps between the edges of the door (D) and frame, to align the door within the inner frame.

The purpose of the present invention was to develop an apparatus for window installation that makes window installation significantly easier not only to a skilled installer but also to an inexperienced person lacking the necessary skills.

In accordance with the present invention, the window installation apparatus comprising of at least one wedge-shaped distance piece has a body connected in a sliding manner to a clamp. Between the body and the clamp, an expansion unit is positioned, comprising a wedge and a lead screw connected by means of a threaded connection to an opening in the wedge. The body has protrusions positioned at its opposite sides, lateral rails mating with the clamp's brackets and an opening in a rest wall for the lead screw. The outer surfaces of the wedge and the inner surfaces of the body and the clamp converge downward at the same angle.

The inclination of the walls of the body and the clamp and the walls of the wedge is 10÷50 degrees, and preferably 30 degrees.

The opening in the rest wall for the lead screw is preferably elongated oval in shape.

Inner walls of the body and the clamp comprise vertical recesses to accommodate the screw.

Additionally, the apparatus comprises a cover connected in a sliding manner to the clamp, intended for extending the working range of the apparatus.

The device according to the present invention offers a simple solution that makes window installation significantly easier. The device is reliable and easy to operate. The use of three (and preferably four) such devices makes it possible to fit a window in the window opening in a short time, even by one person only.

The subject of the invention is presented in two embodiments in a schematic drawing, where

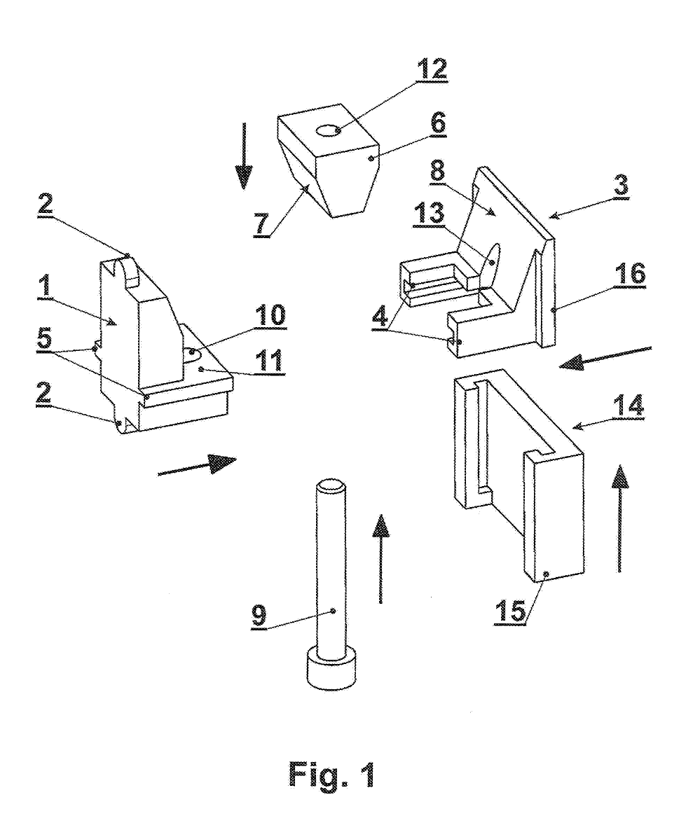

FIG. 1 is an expanded view of the window installation apparatus in its first embodiment (perspective view),

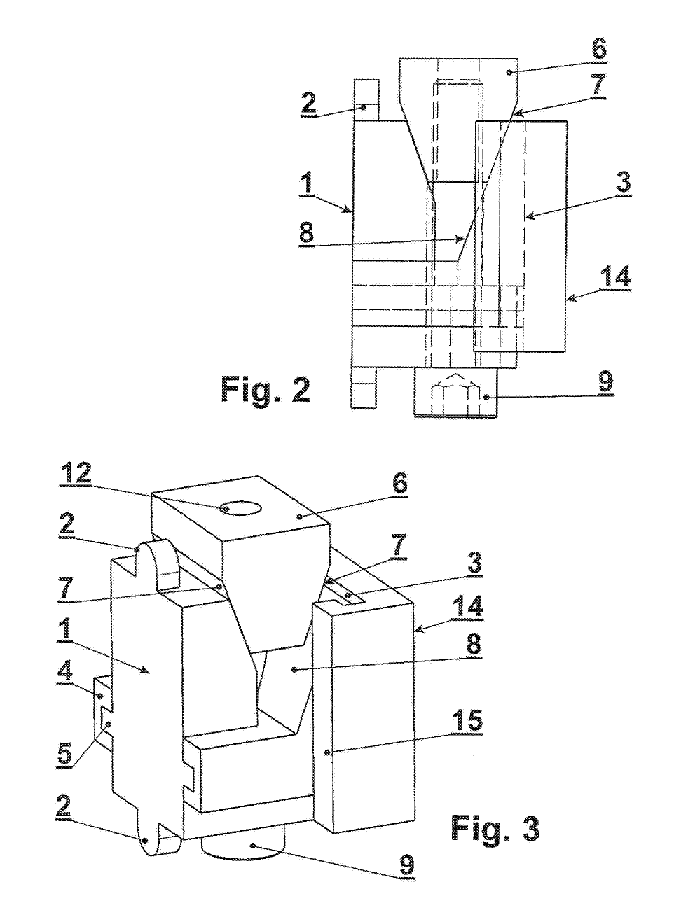

FIG. 2—window installation apparatus in its first embodiment (front view),

FIG. 3—the same apparatus (perspective view),

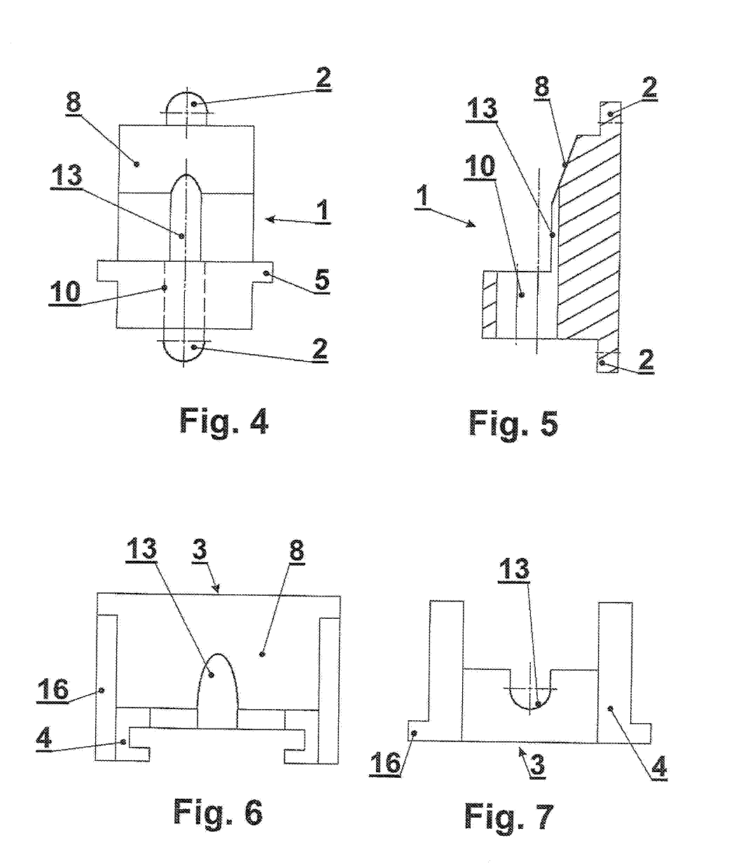

FIG. 4—body of the apparatus (front view, as seen from the clamp),

FIG. 5—axial section of the body,

FIG. 6—clamp (front view, as seen from the body),

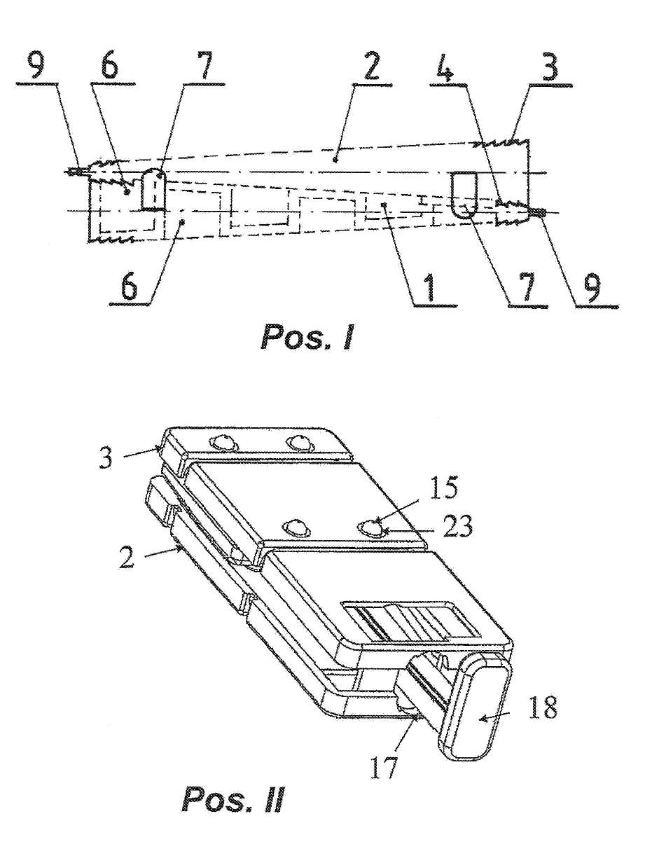

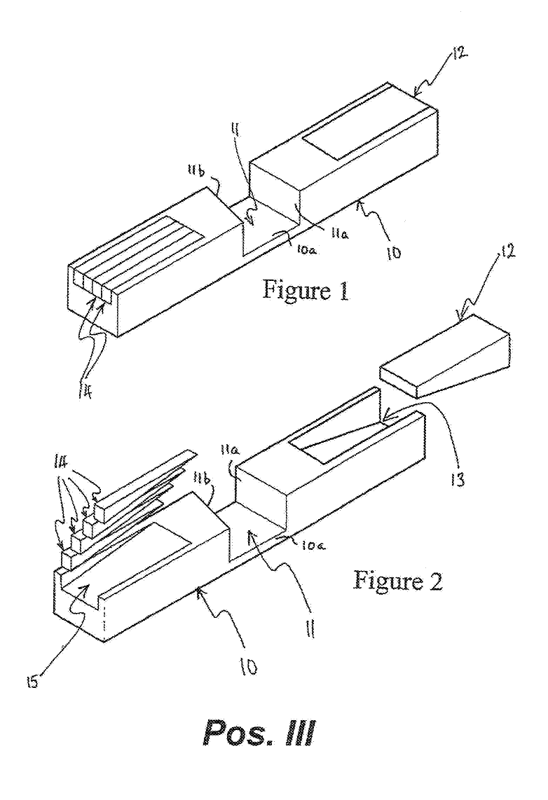

FIG. 7—clamp (bottom view).

The window installation apparatus according to the invention has been used for the installation of a PVC window. Four such devices were used.

Each device was made of a plastic material technically known as POM (polyacetal), considered to be one of the most rigid and robust thermoplastics.

The window installation apparatus comprises a body 1 intended for quick installation outside a PVC window frame (not shown in the drawing) near its corners by means of protrusions 2 extending from the body 1. The protrusions 2, positioned on opposite sides of the body 1, lock in a rail (not shown in the drawing) positioned outside the window frame.

The body 1 interacts with a clamp 3, connected in a sliding manner to the body 1 by means of brackets 4 of the clamp 3 and the rail 5 formed out of the sides of the body 1. Furthermore, the apparatus comprises an expansion unit consisting of a wedge 6 positioned between the body 1 and the clamp 3.

Outer walls 7 of the wedge 6 converge downwards at an angle of 30 degrees. Likewise, inner walls 8 of the body 1 and the movable clamp 3 (facing the wedge 6) incline at an angle of 30 degrees. Furthermore, the apparatus comprises a steel lead screw 9.

The lead screw 9 is positioned in the body 1, in an oval opening 10 made in a rest wall 11, against which its head rests from the bottom. The other end of the lead screw 9 is threaded into an opening 12 in the wedge 6.

Inner walls 8 of the body 1 and the clamp 3 comprise vertical recesses 13 to accommodate the screw 9.

Driving the lead screw 9 into the wedge 6 pulls the wedge 6 towards the body 1, as a result of which the walls 7 of the wedge 6 press against the inner walls 8 of the body 1 and the clamp 3. The interaction of the inclined elements 7 and 8 of the apparatus pushes the clamp 3 outwards, thus expanding the apparatus.

In the case of one of the four devices used according to the invention, the installer found that the expansion range was insufficient because the gap between the window and the wall was too wide. Therefore, he used an additional element in the form of a cover 14 for the clamp 3. The two elements are connected in a sliding manner by means of brackets 15 of the cover that mate with side rails 16 of the clamp 3.

By using the devices according to the invention a single operator easily fitted and immobilized the window frame in a correct position in the window opening before its final installation by means of expanding foam.

### LIST OF REFERENCE

1—body
2—protrusion of the body
3—clamp
4—clamp bracket
5—rail
6—wedge
7—outer wall of the wedge
8—inner wall of the body and the clamp
9—lead screw
10—rest wall opening
11—rest wall
12—wedge opening
13—recess
14—cover
15—cover bracket
16—side rail

1. A window installation apparatus comprising at least one wedge-shaped
distance piece characterized in that it has a body (1) connected in a sliding manner to a clamp (3), between which an expansion unit is positioned, comprising a wedge (6) and a lead screw (9) connected by means of a threaded connection with an opening (12) of the wedge (6), wherein the body (1) has protrusions (2) adapter to lock in a rail positioned outside the window frame, latera] rails (5) mating with brackets (4) of the clamp (3) and an opening (10) in a rest wall (11), against which the head of the lead screw (9) rests, while the outer walls (7) of the wedge (6) and the inner walls (8) of the body (1) and the clamp (3) converge downward at the same angle.

2. The apparatus according to the claim 1 characterized in that the inclination angle of the walls (8) of the body (1) and the clamp (3) and the walls (7) of the wedge (6) is 10+50 degrees, and preferably 30 degrees.

3. The apparatus according to the claim 1 characterized in that the opening (10) in the rest wall (11) accommodating the lead screw (9) is preferably elongated oval in shape.

4. The apparatus according to the claim 1 characterized in that the inner walls (8) of the body (1) and the clamp (3) comprise vertical recesses (13) to accommodate the screw (9).

5. The apparatus according to the claim 1 characterized in that it additionally comprises a cover (14) connected in a sliding manner to the clamp (3).

6. The apparatus according to claim 1 characterized in that it additionally comprises an intermediate wedge (17) positioned between the body (1) and the clamp (3), whose outer walls (18) and inner walls (18′) converge downwards at the same angle as the outer walls (8) of the main wedge (6).
